(19) United States
(12) Patent Application Publication
(10) Pub. No.: US 2009/0204469 A1
(43) Pub. Date: Aug. 13, 2009

(54) Internet Method, Process and System for Publication and Evaluation

(75) Inventor: Henry Markram, Lausanne (CH)

Correspondence Address: NIXON & VANDERHYE, PC, 901 NORTH GLEBE ROAD, 11TH FLOOR, ARLINGTON, VA, 22203, US

(73) Assignee: FRONTIERS MEDIA S.A., Epalinges (CH)

(21) Appl. No.: 12/302,722

(22) PCT Filed: May 30, 2007
(86) PCT No.: PCT/IB2007/052034

§ 371 Date: Apr. 14, 2009

(30) Foreign Application Priority Data
May 30, 2006 (IB) PCT/IB2006/051709

(51) Int. Cl. G06Q 99/00; G06Q 10/00; G06F 17/30; G06Q 50/00

(52) U.S. Cl. 705/9; 705/1; 707/104.1; 707/E17.044

(57) ABSTRACT

A technical method for evaluation, publication and distillation of information, such as scientific articles and other similar work, said method, process and system comprising at least the following technical process steps (1) an interactive online reviewing process of said information before it is published; (2) a publication process of said information if accepted; (3) an evaluation process of said information once published; (4) a distillation process of said published information in a tier filtering system based on said evaluation process.

### FIELD OF THE INVENTION

The present invention concerns a novel tier academic model for the publication of scholarly articles, peer review, collaborative online publishing, evaluation and distillation of scholarly articles and other similar information. The present invention describes a series of linked internet-based processes that make up a highly automated publishing system that is capable of processing a vast number of article submissions for their excellence and social relevance in an objective manner.

### BACKGROUND OF THE INVENTION

Scholarly research is normally published by journals after review and editing by peers in the field to safe guard the quality of research claims. The challenge faced by society is that there are currently over 2.5 million scholarly articles that are processed for publication each year. The solution has been to fragment the publication process into over 22,000 journals of varying degrees of specialty. This system has developed serious cracks and flaws such as long publication delays and inefficiencies, and the lack of fairness, objectivity and transparency in reviewing and processing articles as numerous small groups are formed even within communities to band together to ensure their publication survival. The stakes are high since research careers are typically based on the publication record in the well-known “publish or perish” law of natural selection. This fragmented process of sorting such a vast number of research discoveries each year into the most novel and important has rapidly degenerating into the “law-of-the-jungle” where politicking and lobbying is a major activity and determining factor that ensures that a research discovery is put forward as “leading edge”. These cracks and flaws are leading to widespread abuse of the current publishing system as commercial publishers increasing exploited the fragmented research communities to capture and control the growing scientific publishing market, estimated at a annual worth of around $10 billion in the USA alone.

The invention involves a series of linked internet-based processes and algorithms as part of a novel tier-based academic model for scientific publishing, which together forms a highly automated publishing system that works against the current trend of fragmenting scholarly research and all the problems that come with such fragmentation, to enables an automatic unbiased sorting of articles for the excellence and social relevance and an integration of all fields of scholarly research.

The new internet-based method for publishing scholarly research that has been invented allows rapid and fair claiming of priority of research discoveries, internet-based real-time review forum for collaborative review to ensure the highest quality of research discoveries, internet-based real-time collaborative authoring of referee commentaries, an internet-based arbitration process, a novel method of rewarding referees for their constructive reviews. The publishing system according to the invention, also uses novel internet-based algorithms to evaluate the impact of articles, authors, referee's, and editors on the community and employs a novel tier-like filtering system to distil scientific excellence & social relevance from the most specialized to the lay levels.

The current scientific publication system is experiencing serious problems due to bias, prejudice, preconceptions, restricted access due to vast commercial interests, powerful groups with vested interests, and paradigmatic inertia.

In the current system Authors spend enormous amounts of money (in neuroscience this can amount to over $1,000,000 per project) and the time of a number of researchers (typically multiple PhDs and Postdocs) to produce a study. The study is submitted to a scientific journal where an editor, is assigned to the submission. The editors are put in charge of making the initial selection of whether the paper is suitable for the journal, sufficiently novel and of interest to the scientists that are targeted by the journal. In some cases, the editor supposedly consults an editorial board, but it is well known in the field that the mode of his/her presentation is the major influence on the initial selection. Thus, after a rigorous scientific study, the work of the Authors, are in the subjective hands of one editor who is typically less expert than the authors.

The goals of the journals are to become the number one journal in terms of their subscriptions, the demand to publish in their journal, and their impact for the papers published in the journal. The two standard ways of achieving this is to give priority to well known scientists and to reject without review, as a rule, as many as 90% of submissions—an elitist strategy.

If a paper is selected for review, the editor sends the paper typically to 2-3 referees. These referees are experts in the submitted work's field and are therefore mostly also competitors to the research of the submitting Authors. Since there are major disagreements in many concepts in science, a large number of referees may display bias against the concepts set forth in the study, especially for concepts that threaten to change the dogmas. Nevertheless, only such experts can evaluate the quality of the research and journals must rely on the integrity of these scientists. With the intense competition in the science field and given this subjective selection at submission, it is commonplace for scientists to use this platform to control the direction that they would like to see science move towards. The paper's fate is therefore strongly dependent on whether it lands with those colleagues on which the authors are on good terms with—their friends. The current publication system is therefore to a great extent a friend-serving-a-friend system and the powerful “clubs” can have virtual absolute control over the direction of science in certain fields. In essence the current publication system is one of the most well disguised corrupt systems in society. From a social history perspective, the current publishing system is in fact simply at a primitive stage of evolution where the “law-of-the-jungle” still rules. The invention laid out is a “mutation” that allows the next step in the evolution of an emerging knowledge society where knowledge is sorted for reliability in an objective manner and freely accessible to all.

Given that science and technology profoundly shapes the nature and nurture of society, the problems in the current publishing system must be addressed urgently. This system has the greatest impact on researchers in countries that are less developed in science and technology and therefore also acts to hold back developing countries from establishing high-level research and rising to the challenges of the new millennium. Failure to address this problem could increase the digital and information divide in the world.

The reviewing process is also extremely inefficient and can last months and even years as authors battle referee bias before they drop to the most obscure journals that are keen to become the “new kid on the block” or until they find referees that either are “friendly” or that are not directly in the field of the paper. This also has the counter effect of a lower quality reviewing of research. Most authors need to resubmit to a second, third and even forth journal starting from scratch with a new set of referees. It is not uncommon that the same negative referee accepts to review the same paper submitted to a different journal allowing a single referee to block the publication of a major research project in multiple journals. The referees perform this task for free and have no incentive to be constructive and helpful towards the authors. Indeed the prevailing incentive seems to focus more on the chance to control the direction of science than the chance to help other researchers improve their work. This system therefore losses the immense potential value of expert consultants that could serve to enhance the quality of research in other labs worldwide.

Authors typically wait for 2-4 months before hearing any news back from referees and then must revise and resubmit repeatedly. Once the authors have managed to pass through this grueling process, during which time they could have been carrying out other research, they must pay large sums to publish the figures of their paper—essentially this is a disguised way of charging Authors to publish the paper—such handling costs can run up to many thousand of dollars.

The author then passes over copyright to the journal and must then buy their own published work back from the journal. The journal does not actively take any responsibility to promote the articles published except for those subjectively selected by the Editors, as is done by book publishers, on the contrary, journals restrict access because they earn significant amounts through subscriptions.

Finally, while journals are making exorbitant profits from the work of researchers, they provide nothing in return for outstanding research—i.e. none of the publication profits come back to the researchers that supported these journals. Even when it comes to support for conferences, the industrial companies are more supportive than any scientific journal.

### Summary, Major Faults of the Current System:

1. Editorial Quality: After a rigorous objective scientific study is carried out, the selection of the study for publication is made subjectively by editors that are commonly not as expert as the authors in the field.
2. Significant Referee Bias: The value of scientific research is judged by 2-3 researchers—a democratic solution does not exist. This process severely hinders major paradigmatic shifts as many revolutionary studies are often forced to be published in low profile journals and are only recognized decades later as crucial discoveries.
3. No Benefits to Referee: The current publication system does not pay or compensate Referees for their work as expert consultants.
4. Under-utilization of Referee Expertise: The current system does not harness the expertise of Referees in a positive manner to further the excellence of science. With the massive increase in specialization on the one hand and multi-disciplinary research on the other hand, Referee expertise could add tremendous value to worldwide research.
5. No Constructive Collaboration: There is currently no constructive collaboration between submitting Authors and Referees. A system that provides the clear directive for consultation and incentive, such as a payment, to be constructive, is lacking.
6. Long Delayed Referee-Author Interaction: The interaction between Authors and Referee is carried out with months of delay between communications—no immediate real-time interaction system exists.
7. No Author Rights: In the current publication system, Authors have no rights in the process of publishing their research. A system that establishes and enforces Authors Rights, equivalent to everyone's rights to file a patent, is lacking.
8. No Fair Declaration of a Discovery: The current publication system does not allow for fair declaration and claiming of scientific discoveries. It is not uncommon that papers are repeatedly rejected while others hear about the research and publish a competitive paper taking the credit.
9. Journal Standing Determines Scientific Impact: In the current system, two identical papers published in different journals will have a very different impact as will two identical papers published by Authors from the leading “clubs” relative to those researchers in underdeveloped countries.
10. No Promotional Responsibilities: The current publication system does not take responsibility for the promotion of research in the same way that book publishers promote the book.
11. No Services to Authors: The current publication system does not provide any means by which to place new scientific findings in the context of the world context—past and present research, technology, clinical practice, industries.
12. Restricted Access: Almost all published material is restricted to those that purchase access rights. Only the rich institutions, industries and countries can afford this privileged access.
13. No Support for Science: The current publication system does not provide any support back to researchers in the form of awards or conference support or fellowships. A considerable fraction of the funds accrued from the publication of research should go back to research.

### SUMMARY OF THE INVENTION

The method of the present invention aims to promote and disseminate information, in particular academic research in all countries and addresses the main problems in the current publishing system. The processes of the present invention involves a series of linked internet sites and databases of information related to authors, editors and referees that execute a plurality of programs, operations and algorithms that are capable of automatically guiding and constraining authors, referees and editors in a system that is capable of automatically processing vast numbers of articles across all scholarly fields for collaborative authoring, reviewing, publishing, evaluating, and sorting according to their scientific excellence and social relevance.

Currently, the publishing process is i) mostly restricted access, ii) complicated and time consuming, ii) biased and controlled by local lobbies and powerful journals, and iii) not geared towards the needs of Authors. In such a publishing system the prestige comes from where one publishes and not necessarily what one publishes.

On the other hand, the method, process and system according to the present invention uphold the rights of Authors, address their needs and provide Authors a rapid, convenient, unbiased, and comprehensive publishing environment with prestige being guaranteed by the highest quality constructive peer-review and by an evaluation system that involves the entire research community. The present invention defines a novel publication model, the tier journal system, which allows the distillation and filtering of scientific excellence from the most specialized levels to a more general level in order to eventually automatically and fairly deliver the science community for example the neuroscience community the most outstanding and excellent research in the field. The tier journal system for scientific publication is the first such system and does not exist in any of the over 22,000 journals currently operating. The recognition system according to the present invention also involves an automatic objective awards system for excellent research, Authors and Referees that are globally and democratically selected by the entire community as judged by articles that succeed to climb the tiers of the publishing system. The system also creates a novel social networking that will be possible with the profiles of all the authors, referees and editors.

The present invention can be made into a viable business model by launching as an Author-pay journal which also enables open access and free dissemination of research. The invention also involves a series of linked services that provide the first comprehensive environment for authors where a wide spectrum of researcher needs are addressed related to knowledge seeking, creation and discovery and knowledge sharing. The present invention involves linking the most advanced internet technologies in a novel manner to bring scholarly publishing into a new generation.

More specifically, the present invention is related to a technical process of interactive on-line reviewing of information, such as scientific articles, a process of publication of said information, a process of evaluation of said information by the public and a process of promoting said information based on the evaluation by the related and distant research communities and even the public.

As will be readily understood from the following description, the method and processes of the present invention is based on online real-time exchanges on a network with computers, such as the internet, on sending information and receiving said information through this network under an electronic form, on automatic or manual selection and sorting of profiles, for example of editors and referees, in electronic databases, on the basis of predetermined rules, on compiled databases of registered authors and also other matching algorithms of profiles, on evaluation of the information provided and on applying predetermined rules to the result of the evaluation. All these steps involve a technical treatment of information under electronic form, said technical treatment being carried out by technical means, such as computers, processors and networks and using a series of linked programs and algorithms for analysis and sorting of information.

### BRIEF DESCRIPTION OF THE DRAWINGS

The accompanying drawing illustrates an embodiment of the invention by way of example and is by no way of limitation.

FIG. 1 illustrates a block diagram of the process of Submission and Review of information according to the present invention;

FIG. 2 illustrates a block diagram of the process of Referee Assignments according to the present invention;

FIG. 3 illustrates a block diagram of the process of Publication, Evaluation and Distillation of information according to the present invention.

### DETAILED DESCRIPTION OF THE INVENTION

### 1. The Model

The present invention method, process and system constitutes a paradigm shift from the current review, evaluation and recognition processes. The goal of present invention method, process and system is to ensure that all research described in the article are valid and flawless and to raise the quality of the research to its highest possible level, while ensuring the rights of Authors to publish their work in a fair, unbiased and efficient system. The present invention method, process and system democratically evaluates research by enabling the entire research community to decide on scientific excellence of publications using automated reader-based evaluation algorithms. Novel paper impact algorithms monitor and operate on each article to determine the impact of the paper on the readers and subsequent research. The present invention method, process and system departs from the current publication models by filtering and distilling outstanding research and introducing the first Tier Publication Model. Articles are submitted to the electronic Specialty level and application of the Evaluation Process allows the identification of the most outstanding research, which are then invited to be published in a Field Level making it accessible to the wider scientific community. The present invention method, process and system will further depart from the current publishing model, which returns nothing to Authors, to the Recognition & Awards System, in which democratically and globally determined scientific excellence will be rewarded with prizes and research grants. An Editorial Selection System enables the democratic selection of Editors for Specialty and Field Journals based on merits such as scientific excellence and social relevance.

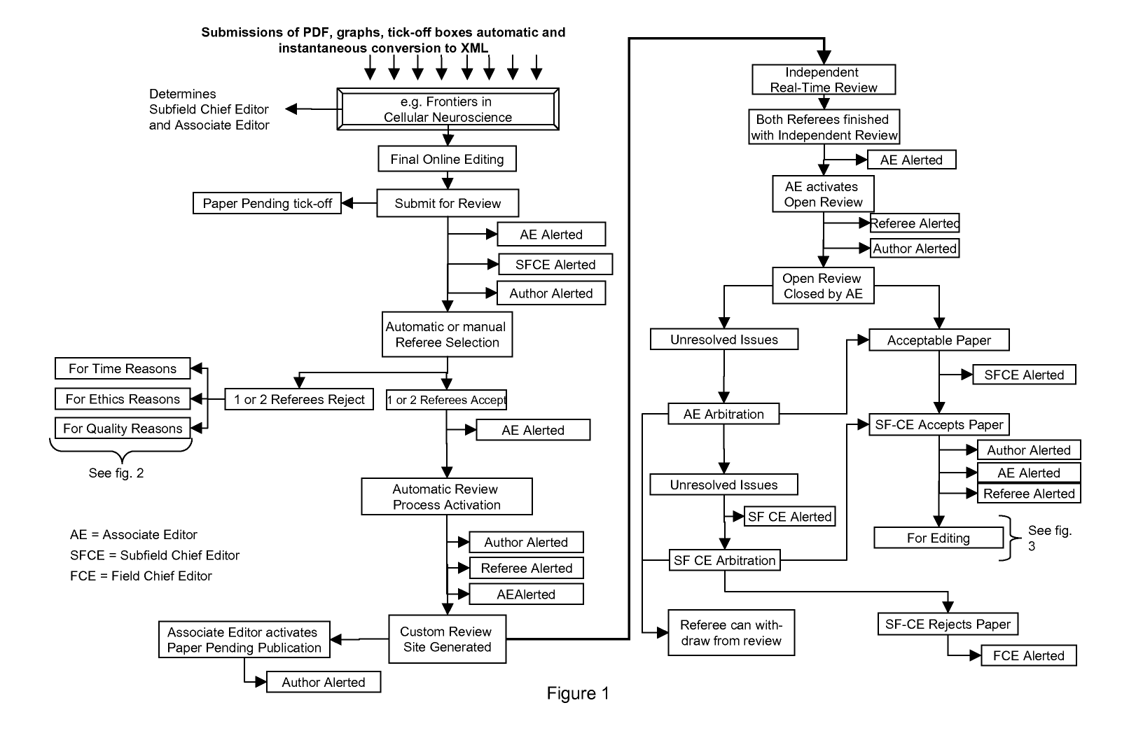

The following detailed description should be read together with the attached FIGS. 1 to 3 and uses the non limiting example of a Journal in the field of Neuroscience. Of course, the principles of the invention may be applied correspondingly to any field (Medical, Scientific or other).

### 1.1. Review and Publication System

1.1.1. Overview (FIGS. 1-3)

The invention addresses the problems or current review system, in which the Authors have no rights and which is characterized by lobbyism, subjectivity, bias, a destructive rather than a constructive and helpful attitude and lengthy Author-Referee communication delays. In this system Authors have no rights and Referees are exploited, resulting in a negative and destructive process.

It is the invention's foremost aim to uphold the rights of Authors to an unbiased review process by
an automated Referee selection process,
a new mandate for editors and Referees restricted to objective issues,
an immediate paper pending publication to secure Authors discoveries during the review process,
the right of an Author to initiate an arbitration process in the case of a dispute, and
a real-time interactive review forum whereby Referees become an integral and constructive partner by helping the Author de improve their work.

To ensure rapid publication the invention provides
a means to rapidly publishing a Paper Pending abstract,
a fully automated internet-based paper handling system,
a real-time review forum for interactive review,
internet-based joint commentary preparation facilities,
a real-time copy-editing forum, and
immediate internet publishing.

It is also the invention's aim to uphold Referee rights, value their expertise and constructive collaborations with Authors and compensate their work by
granting free access to many services,
Referee-Authored publications of commentaries on the reviewed work,
becoming eligible for editorial positions,
becoming eligible for prizes and awards.

1.1.2. Author Registration

Authors must be registered, for example in an Author database, in order to submit articles. After registration each Author obtains a dedicated Homepage. Author profiles include a CV and list of publications, and the profile must be accredited by a person already registered in the system. During launch phase, Authors may request Associate Editors to accredit their profiles. Profiles will be used to generate an internal Author Impact Score (AIS), which is based on several novel impact evaluation algorithms. The Author Impact Score can also be matched against the Referee Impact Score (RIS) to allow an optimized Referee-Author match. AIS will be dynamically updated based on continued publications. Authors are able to update and maintain their profiles. The profiles have the primary purpose to allow the evaluation of publications and facilitate the networking between scientists, but will also become a valuable standardize CV that Authors may also choose to allow Readers to view in a Who-is-Who Site.

1.1.3. Submission (FIG. 1)

All papers must be submitted electronically through the internet. The submission system in the present invention is more than a mere uploading of files. The system allows Authors to collaboratively compile and edit the paper within their Customized Homepage.

1.1.4. Editor Selection (FIG. 1)

Authors select an Associate Editor (AE) that best covers the field of research of the paper. In a variant, the Associate Editor may be chosen automatically on the basis of a matching of key-words qualifying the Editor and the information (article) to be published.

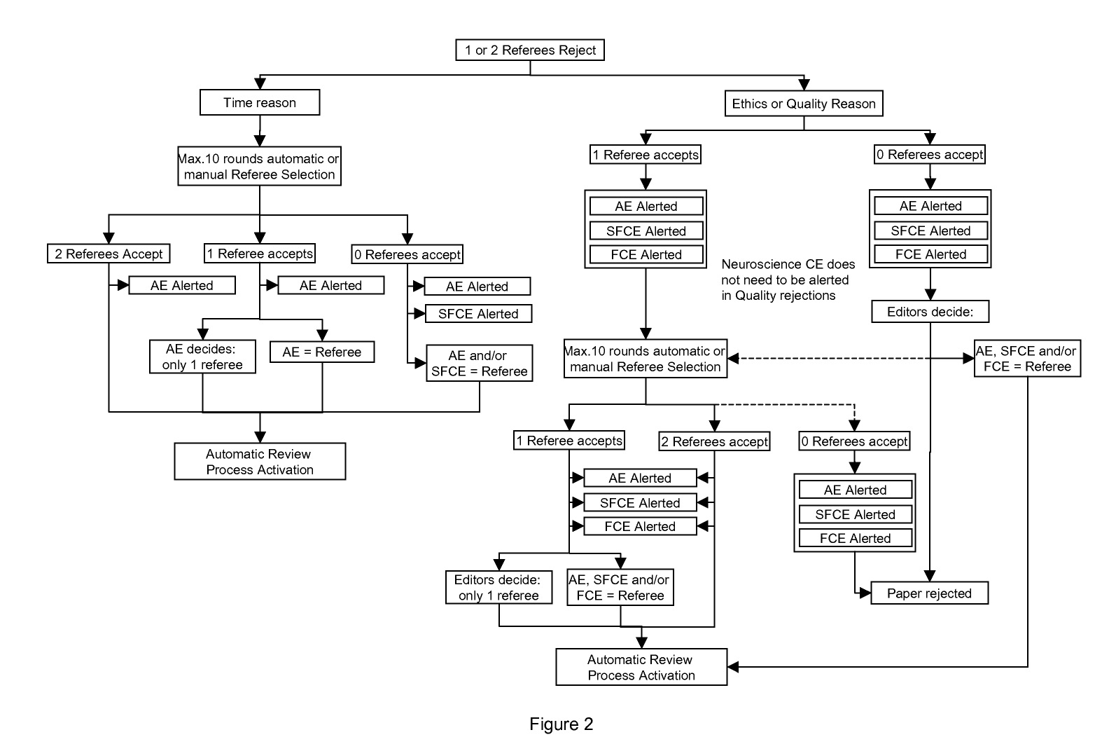

1.1.5. Referee Selection (FIGS. 1 and 2)

After submission, Referees are selected from a database. While this process will be completely automated in the future, preferably during the launch phase, Associate Editors are preferably required to manually select Referees of their choice. All Referees must be registered with their profile (CV, area of qualification etc) in the system, for example in a Referee database, as their profiles are essential for the automated Referee selection process. Referees will be assigned a Referee Impact Score to aid in the most appropriate automated assignment of papers. The key words and paper contents are passed through a “Fields of Expertise Algorithm” which allows the automatic retrieval of all suitable Referees from the database. Preferably, the average Author Impact Score is used to automatically select Referees with Referee Impact Scores that are a few points above that of the Authors. For Authors with the highest scores, all Referees in the upper score ranges will be valid Referees for the paper. After automatic selection of the most appropriate Referees, the recent and current work load will rank the selected Referees and begin automatically inviting the Referees from the top and keep going down the list until two Referees are found to review the paper.

In case only one or no Referee can be found, Associate Editors and Specialty Chief Editors (SFCE) can act as Referees and review the paper.

1.1.6. Automatic Referee Identification Process (FIG. 2)

Citation-based automated Referee identification & assignment:
Find related papers
Find number of citations for each related paper
Extract Authors of related papers
Calculate individual related paper Author citations
Rank Authors according to citations
Re-rank Authors according to Referee work-load in Frontiers
Invite top 5 Referees to the review forum
Two required to start the review
If not enough Referees after 2 business days, invite 3 more Referees
If 2 Referees are not obtained, automatically alert associate editor

1.1.7. Closed to Open Interactive Review System (FIG. 1)

A major objective for the invention is to remove bias from the review system. One of the core factors that supports biased reviews is the invisible screen between the Authors and Referees. In the current system the Author remains permanently anonymous, while in the system according to the present invention the Referee remains anonymous only during the review period.

After the review, the screen is lifted and the Referees will be known. This system achieves both the effect of protecting Referees that wish to withdraw from the review process and ensuring that Authors address all issues raised by Referees seriously. Referees are also invited to write a Commentary, which is a one-page summary of the paper co-Authored by all participating Referees. The decision to write a Commentary is up to the Referees and will be based on their subjective evaluation of excellence of the paper allowing Referees still to influence to some extent the Readers and guide them to the best papers. These commentaries will be referenced and citable and will be a major incentive for Referees because the current trend is for readers to read more meta-papers before going to the deeper original studies. In addition, the impact of commentaries will be used to grant awards to Referees. Referees will also be asked to provide a grade to papers, but these grades will be kept within a General Comments section of the paper and not immediately visible to the superficial scanning of the information to prevent such grades from influencing the Readers.

1.1.8. Paper Pending (FIG. 1)

The first task of the Referees is to determine whether they are willing to review the paper by scanning through the paper. If two referees can be found to review the paper then the Title, Abstract and Author list is immediately published in the invention as “Paper Pending”. This process is expected to take place within a few business days.

1.1.9. Rejection without Review (FIG. 2)

At the submission stage, Referees may decline to review the paper if they judge that the quality of the paper and research is so poor that the paper cannot be reviewed. Poor quality of a paper refers to objective errors in the experiments or very poor linguistic style (which cannot be expected to be corrected by expert Referees). They may also decline to review a paper, if ethical standards are not met. If one referees declines to review the paper for any of such reasons, the Associate Editor is automatically alerted to arbitrate and judge whether the Referee has made a fair decision. The Associate Editor may invite more Referees or choose to co-referee the paper. If two Referees decline to review the paper and the Associate Editor agrees with the Referees, the Specialist Chief Editor is alerted, who then has to make the final decision about the quality or ethics of the paper and reject the paper if she/he agrees. The Specialist Chief Editor can however override the Referees and Associate Editors and invite more Referees, or choose to referee the paper alone or co-referee it.

Instead of outright rejection, the Authors are informed that the paper cannot be reviewed in its present form and they are referred to a Consultancy Service Center where consultants can work and train Authors to enhance the quality of their research and to write scientific papers or other information according to the present invention. After the research papers have passed through this training system, Authors may resubmit the paper for consideration.

1.1.10. Real-Time Interactive Review (FIG. 1)

As soon as two Referees agree to review the paper, a real-time internet site is created that serves as a Real-Time Interactive Review Forum. In this site, Referees make comments that can be viewed by other Referees as well as the Author in real-time and the Author can revise the paper in accordance with the comments, in real-time, much like an internet discussion group. The Authors and Referees are notified automatically when comments have been made or addressed. Chief and Associate Editors can enter the site and oversee the review process and can directly contact the Referees or the Authors to handle an issue. The mandate for Referees is to ensure that the experiments are valid, the results are flawless and the quality is as high as possible. Referees can only make a strong stance on objective issues and can only reject the paper based on objective errors or if Authors fail to comply with scientific language standards.

The review process is manually started by the Associated Editor with a Closed and Independent Review Forum. Here the Authors can see referee comments in real-time to begin preparing their responses. Referees make their comments independent from each other and cannot see the other Referee's comments to ensure independence of Referees criticism. Once finalized, the Associated Editor is automatically alerted and manually initiates the Open and Interactive Review Forum. Here the Authors and Referees can see all comments and can immediately start interacting on the issues. Each comment can be addressed individually and history logs are created. Once all comments are resolved to the Referees' satisfaction, the Associate Editor is automatically alerted to close the Review Forum, and thus the paper is fixed. The Associate Editor then initiates the publication process (copy editing, etc).

1.1.11. Arbitrations (FIG. 1)

An aim of the interactive review forum is to allow Referees to converge on objective errors, but should a dispute arise that threatens rejection because of objective errors, then the Author may trigger an arbitration. Initially, the Associate Editor will arbitrate and involve all Referees in a discussion to resolve the problem. The Associate Editor may bring in additional Referees to consult on more specialized topics. A paper can be rejected if the arbitration rules that the objective error(s) stands. Referees may also trigger an arbitration if they feel that the Author is unwilling to make the required changes. A Referee may also withdraw from the review process if he/she disagrees with the other Referees and the arbitration rulings. In the case of a Referee withdrawal, the Referees' identity remains anonymous. A Referee withdrawal may require the recruitment of a new Referee, which slows the review process and Authors therefore need to co-operate as much as possible to address the concerns of Referees.

1.1.12. Acceptance (FIG. 1)

Both Referees are required to approve the publication of a paper and the Review Forum is closed. The Associate Editor is automatically alerted and accepts the paper for publication and transfers it to the publication process (see below).

1.1.13. Commentaries

After acceptance, a real-time collaborative site can be created for the Referees to write a brief one-page Commentary providing a more general description of the research. The Commentary page is opened automatically only when both Referees decide that the paper is of high enough quality that they are willing to write a Commentary. These Commentaries are published in the same issue and papers with Commentaries will be flagged for Readers to identify.

1.1.14. General Comments

Preferably, Referees comments and a subjective grade (1-10) will be added to a General Comments page associated with the published paper. The General Comments page will also allow Readers to make further comments and to pass their subjective voting of the paper. To reach the General Comments of a paper, a Reader will need to enter the Full-Text version of the paper and select the option. Readers will be able to customize their notifications of new research published based on any one or combination of objective and subjective scores.

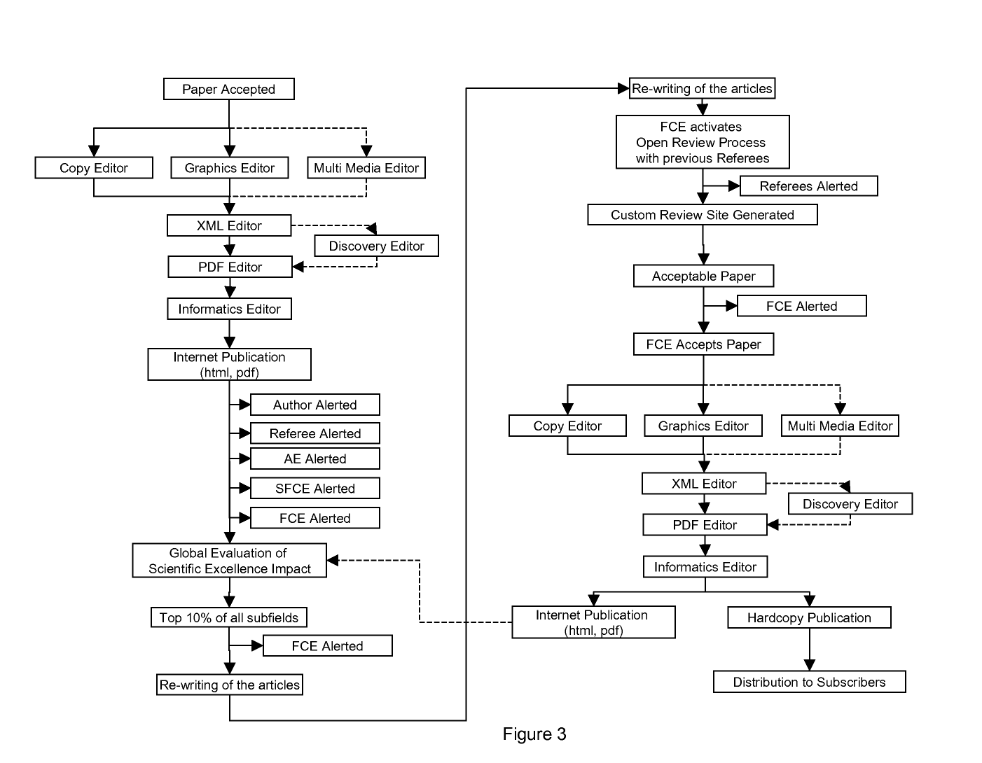

1.1.15. Copy & Graphics & Multimedia Editing (FIG. 3)

After submission of the Commentary, a real-time site is created for copy-editing. A professional Copy Editor (CE) is automatically selected by the system. The Copy Editor applies a predetermined Style Sheet to the paper. Only the Copy Editor can modify the manuscript at this stage, but the Authors can answer questions posed, interactively. The Commentary is also copy-edited and Referees may answer questions posed by the Copy Editor. Notifications will be used to alert Authors of issues to be addressed in the copy-editing.

Multimedia Editing can be applied and involves the linking of power-point presentations, animations and visualizations of experimental procedures and results.

1.1.16. XML and PDF Editing (FIG. 3)

Upon completion of the copy-editing, the paper is forwarded to the XML and PDF Editors who create the internet and .pdf documents according to predetermined Style Sheets.

1.1.17. Discovery Editing

The XML and PDF documents are forwarded to the Discovery Editor (DE), who builds the discovery environment of the paper. This comprises the linking of the paper to relevant sites in the internet (e.g. relevant research institutes and companies, related papers, related topics, etc.).

1.1.18. Internet Publishing (FIG. 3)

Upon completion of the discover-editing, an email or other similar notice is sent to the Copy Editor (CE) and the Informatics Editor (IE). The Copy Editor places the paper into a high quality publishing layout and generates an interactive pdf providing live links within the paper and with the internet. The Informatics Editor publishes the paper, the commentary and the discovery environment on the internet in XML format and attaches the pdf document for downloading. Authors, Referees and Editors are notified that the paper is published.

### 1.2. The Evaluation System

### FIG. 3

The Evaluation System according to the invention allows all readers to participate in the evaluation of research articles. It is the first system to allow the democratic evaluation of research articles by the entire scientific community, not only a few journal gatekeepers. In order for such a system to function, Readers who want their reading statistics to count towards the excellence and relevance scores of published papers are required to submit a comprehensive profile of their professional career. It is not required to register with the system in order to access Journals, but it is required if the Reader wishes to contribute to the Scoring System. Reader access is tracked and any one reader can contribute only once towards each category. Since profiles are used to score Readers (see below) and hence the contribution to the Reader activity, more comprehensive profiles will contribute more significantly towards the evaluation process.

1.2.1. Reader Evaluation

1.2.1.1. General Qualification Index

The profile of each reader entered at registration is used to calculate the General Qualification Index based on the educational levels.

1.2.1.2. Reader Distance Index

The Reader Distance Index determines the distance in expertise levels between an article/Author and the Reader.

1.2.1.3. Specialist Expertise Index

The aim of the Specialist Expertise Index is to provide a higher score for the more educated and more specialized Readers.

1.2.1.4. Social Relevance Index

The aim of the Social Relevance Index is to provide a higher score for Readers that are further from the field (i.e. towards the layman), but the score also rises as the Reader is more expert.

1.2.2. Citation-Based Author and Article Evaluation

1.2.2.1. Author Citation Impact

An application server retrieves all publications listed by the Author in the system profile. Based on the dynamically determined number of citations for each of the papers an Author Citation Impact is computed.

$$AuCI = {\sum }_{n = 1}^{i} {C}_{f} {C}_{t} \cdot {article}_{citations}$$

1.2.2.2. Article Citation Impact

An application server retrieves all publications listed by the Author in the system profile. Based on the number of citations, an Article Citation Impact is computed for each paper.

ArCI=C_{f}Cₜ·article_{citations}

1.2.3. Article Evaluation

1.2.3.1. Article Academic Excellence Impact

The Article Academic Excellence Impact reflects the expertise levels of the reader accessing different parts of the paper. The goal is to award higher scores to articles the more specialized and more expert a Readers is and the deeper he/she accesses the paper.

1.2.3.2. Article Social Relevance Impact

The Article Social Relevance Impact reflects the social relevance of the article. The goal is to award higher scores to articles the more expert, but further away a Reader is from a particular subject and the deeper he/she accesses the paper.

1.2.3.3. Article Impact

The Article Impact takes into account both previous scores and thus can be interpreted as the total Academic Excellence and Social Relevance Score.

FArI=FArEI+FArRI

1.2.4. Author Evaluation

1.2.4.1. Author Academic Excellence Impact

The Author Academic Excellence Impact evaluates the academic excellence of the Author based on the excellence of his/hers articles published according to the method, process and system of the invention.

$$FAuEI = {\sum }_{n = 1}^{i} FArEI$$

1.2.4.2. Author Social Relevance Impact

The Author Social Relevance Impact is the social impact of the Author based on the social relevance of all his/hers articles published.

$$FAuRI = {\sum }_{n = 1}^{i} FArRI$$

1.2.4.3. Author Impact

The Author Impact takes into account both previous scores and thus can be interpreted as the total Academic Excellence and Social Relevance Score.

$$FAuI = {\sum }_{n = 1}^{i} ( FArEI + FArRI )$$

1.2.5. Referee Evaluation

1.2.5.1. Referee Academic Excellence Impact

The Referee Academic Excellence Impact evaluates the academic excellence of the Referee based on the excellence of the articles referred by him/her in the system.

$$FREI = {\sum }_{n = 1}^{i} FArEI$$

1.2.5.2. Referee Social Relevance Impact

The Referee Social Relevance Impact is the social impact of the Referee based on the social relevance the articles referred by him/her in the system.

$$FRRI = {\sum }_{n = 1}^{i} FArRI$$

1.2.5.3. Referee Impact

The Referee Impact takes into account both previous scores and thus can be interpreted as the total Academic Excellence and Social Relevance Score. The Referee Impact can be used to evaluate Referees and make them eligible for an Associate Editor position. All Referee Impacts are used to match Referees with Authors for the review process.

$$FRI = {\sum }_{n = 1}^{i} ( FArEI + FArRI )$$

1.2.6. Editor Evaluation

Similarly to the Referees, Editors (Associate Editors, Specialist Chief Editors and Field Chief Editors) may also be evaluated based on the performance of the articles that they edit. These Editors Impacts can be used to evaluate Editors and allow dynamic cycling of Referees, Associate Editors, Specialist and Field Chief Editors in the system.

1.2.7. Further Evaluation Scores

The invention may use a manifold of algorithms and ranking systems to provide Authors with feedback about their paper performance. These will include, as examples:
paper accesses and downloads (based on demographics)
rankings and comments by expert Referees and Readers

1.2.8. Evaluation Policy

It is the invention's policy to provide Authors with a manifold of services concerning the performances of their papers. In general, Authors can decide whether they want to make their Impact Scores public or keep them private. There will be different levels of accessibility to the Impact Scores and evaluation services to Authors, Referees, Editors and Readers. For example, Editors and Referees will preferably have access to extended services, being able to access not only their own Impact Scores, but also other Authors in the system.

### 1.3. Research Distillation System

### FIG. 3

The biggest problem of today's knowledge society is to cope with the vast amounts of information accumulated each second. As an example, in neuroscience 35,000 research articles are published each year alone—and growing. Overall in academia (Science, Medicine and Technology, Business, Economics, Arts & Humanities) over 2.5 million papers are published per year—also with growing tendencies. This vast and accelerating accumulation of knowledge poses serious questions of how to filter the relevant information, how to decide what are excellent and outstanding research publications. A major goal of the present invention is to allow research to permeate naturally to the public domain in a manner that will not be controlled by any one person or groups of people.

The invention provides the solution to this problem—the first Tier Journal System, which drives the most outstanding research publication up the tiers to gain increasing visibility and accessibility to the general community. In the following, the example will be applied to Neuroscience, but it is possible to apply the model of the present invention to any other field (medical, science, etc) and this is only a non-limiting example used to illustrate the method, process and system of the invention.

In addition, the invention is not just related to another journal, it is the first and only Tier Journal in the publishing system. Distillation of Research will be achieved through an Evaluation System. Based on Article Academic Excellence Impact and to some extent on Article Social Relevance Impact the top 10% outstanding research articles are selected to move up one tier from the specialty level to the general neuroscience level. The weighting of these two Impacts will vary the higher a paper moves up the tiers. While at lower levels the Academic Excellence will dominate, the Social Relevance will become increasingly important at higher tiers.

At launch the Journal Series will consist of preferably two publication tiers: the specialty tier (e.g. Frontiers in Behavioural Neuroscience) and the field tier, Frontiers in Neuroscience. At later stages, there will be preferably four Tiers, which exemplary may look as follows.

Tier 4: Frontiers
Tier 3: Frontiers in Science
   Tier 2: Frontiers in Neuroscience
      Tier 1: Frontiers in Genetic Neuroscience

A research paper that succeeds to move up to the top publication tier, Frontiers, will be among those that have been selected by the most global and unbiased evaluation system possible.

Of course, it is also possible to add tiers and to define another hierarchy or more tiers, this being only an example of a possible embodiment of the invention.

### Tier 1: Submission and Publication in Specialty Journals

1. Research is submitted to the specialist tier (e.g. Frontiers in Molecular Neuroscience).
2. It is reviewed rigorously, fairly and efficiently. It is written in high quality scientific language required by the specific research community.
3. After review the article is published in electronic format in the Specialty Journal (e.g. Frontiers in Molecular Neuroscience).
4. The automated Evaluation System scans and integrates reader activity—who reads and what is read—to automatically select the 10% most outstanding research.

### Tier 2: Selection of Outstanding Specialty Articles and Publication in the Field Journal

1. The 10% academically most excellent and socially relevant research selected by the global evaluation system across all specialties is invited to be published in the Field Journals, e.g. Frontiers in Neuroscience.
2. The articles are re-written with the help of expert copy-editors to make the discovery more accessible to the whole neuroscience community under the supervision of the Field Chief Editors. This offers Authors the opportunity to place their discovery in a more global context within the entire neuroscience field.
3. The article is published in the Hardcopy Field Journal, e.g. Frontiers in Neuroscience.

### Tier 3: Selection of Outstanding Field Articles and Publication in the Category Journals

1. The 10% most outstanding research at the Field Tier level is invited to be published in the Category Journal (e.g. Frontiers in Science).
2. The article is re-written again to place the discovery in an even broader context and understandable to an even broader audience.
3. The article is published in the Category Journal.
4. The Evaluation System then again scans for the academically most excellent and socially most relevant research articles among the Category Journals (Science, Medicine, Technology, Engineering, Business, Economics, Art, Humanities and Social Science).

### Tier 4: Selection of Outstanding Category Articles and Publication in Frontiers

1. The 10% most outstanding research across Science, Medicine, Technology, Engineering, Business, Economics, Art, Humanities and Social Science is finally selected for publication in the Frontiers magazine.
2. The article is re-written to make it understandable and accessible to the general public.
3. The article is published in Frontiers.

This automated Distillation System grants the scientific community a perfectly fair, unbiased and objective evaluation of their research. All experts within a particular specialty can evaluate their publications and the most outstanding research is made accessible to the wider neuroscience community.

The Tier System is supported by awards to Authors, Referees and Associate Editors for articles that succeed to move up a tier.

At launch the Journal Series is preferably made up of two tiers. In the future Frontiers aims to include all fields of academia and will comprise preferably 4 tiers.

### 1.4. Recognition & Awards System

Another feature of the invention concept is to return the revenue back to researchers in the form of prizes, awards and research grants. The system will use its automated, democratic distillation of scientific excellence and social relevance to provide the most prestigious awards—the only awards selected by the entire community. This recognition of excellence as judged by an unbiased democratic evaluation system will emphasize the prestige of achieving success in such a publishing environment. The system will also give awards to Associate Editors and Referees who edited and reviewed high impact papers. In addition, each Journal will seek company sponsorship for additional awards to research published in Specialty Journals and the Field Journal.

### 1.5. Editorial Selection System

Journals are operated by Field Chief Editors (second tier Frontiers in Neuroscience Hardcopy Journal), Specialty Chief Editors (first tier Frontiers electronic Specialty Journals) and Associate Editors, who cover the different specializations within each specialty. Furthermore each Specialty Journal has a Referee Board, whose experts are selected to review submitted articles. Preferably, it is foreseen to make Chief Editor selection a genuinely democratic process as well, in which the Evaluation System helps to determine individual performances. In such an unbiased democratic evaluation system outstanding Referees may become eligible for Associate Editor positions, outstanding Associate Editors for Specialty Chief Editor positions and outstanding Specialty Chief Editors for Field Editor positions. Thus, editorial positions are prestigious and circulated amongst the greatest contributors in the field.

### 2. Journal Organization, Editorial Structure and Workloads

All Journals will receive DOIs and will be accessible through science meta-crawlers (e.g. PUB-MED, Science Direct, etc).

Journals launch with an Author-Pay Business Model, where Authors have to pay a one-time submission and publication fee of approximately $1,000 at the Specialty Journal level. No further publication charges will be made for papers climbing the tiers.

The Journal composition is explained exemplary on the Frontiers in Neuroscience Journals below the described principles being applicable to other fields.

### 2.1. Frontiers in Neuroscience Specialty Journals

Frontiers in Neuroscience Specialty Journals are electronic Journals and are operated by world leaders in the field acting as Specialty Chief Editors. The Specialty Journals are the entry tier for all articles submitted to Frontiers (the only exception to this rule is the inaugural issue, in which all Specialty Chief Editors may publish an article in the Frontiers in Neuroscience Hardcopy Journal). All articles submitted and published at the Specialty tier will be evaluated and rated according to the Evaluation System and if they reach the top-10% most read and downloaded papers in their Specialty will climb up a tier to the Frontiers in Neuroscience Hardcopy Journal. Each Author will receive a detailed evaluation analysis of each article submitted to Frontiers and can track the performance of their papers over time. Frontiers in Neuroscience Specialty Journals will be complied in monthly issues.

2.1.1. Specialty Chief Editors

Specialty Chief Editors (SCE) operate the Frontiers in Neuroscience Specialty Journals. Their responsibilities are to
Recruit and manage their Associate Editorial Board of at least 10 Associate Editors,
help to recruit the Referee Board,
act as arbitrators between Authors and Referees, when an Associate Editor cannot resolve the conflict alone,
review articles when Referees cannot be found to review an article if such an article is judged to be of sufficient quality,
ensure that Associate Editors perform their duties and act according to the rules and regulations of Frontiers,
contribute a paper to the inaugural issue of their Frontiers e-Journal.
promote their Frontiers Journal.

Specialty Chief Editors may have to act as arbitrators between Authors and Referees when an Associate Editor was unsuccessful in resolving a conflict. They may call in expert arbitrators to help resolve the conflict. The Specialty Chief Editor may override the suggestion of an Associate Editor and Referee to reject a paper. The Specialty Chief Editor alone can reject a paper during an arbitration.

Specialty Chief Editors are required to register with in the system and verify other applicants.

Specialty Chief Editors are contracted and receive remunerations for each paper handled.

2.1.2. Associate Editors

The Associate Editors (AE) cover comprehensively the field thus ensuring the most outstanding expert representation of each specialization of the field. Their responsibilities are to
recruit and manage their Referee Board of at least 10 Referees,
act as arbitrators between Authors and Referees,
review articles when Referees cannot be found to review an article which has sufficient quality,
oversee the review process
   manually select Referees (this will be done automatically in the future based on Referee and Author Impact Scores matching algorithms),
   initiate the closed review,
   initiate the interactive review,
   close the review,
ensure that Referees perform their duties and act according to the rules and regulations of the system,
contribute a paper to the inaugural issue of their e-Journal.
promote their Journal.

In the future, building of a Referee database can also be aided and expanded using the Automatic Referee Identification Algorithm as each article is submitted in which case Associate Editors would be responsible for monitoring the Referee selection process.

Associate Editors are required to register with the system and verify other applicants.

2.1.3. Referees

The Referees cover comprehensively the field and ensure expert evaluation and reviewing of submitted articles. Their responsibility is to
review articles according to the rules and regulations of the system.

Referees are required to register with the system and provide their complete profile with CV and publications. In the future, these Referee profiles will be used to produce an initial Author Citation Impact, which will be used when assigning papers automatically to Referees to ensure that each Author receives papers that they are appropriately qualified to Referee.

2.1.4. Arbitrators

Arbitrators will act to resolve disputes arising in the peer review process. Arbitrations are be performed by experts in a particular field and are appointed by Associate and Specialty Chief Editors (in a variant aided through automatic Referee Impact Score determination). Arbitrations are led by Associate Editors (who can act as arbitrators themselves) or Specialty Chief Editors (who can also act as arbitrators themselves) in case a dispute remains unresolved. Specialty Chief Editors alone may reject a paper if Authors refuse to correct objective errors.

2.1.5. Publication Editor

Specialty Chief Editors are assisted by a Publication Editor (PE), whose team oversees the work of Copy Editors, Graphics Editors, Multi-Media Editors, PDF Editors, XML Editors and Informatics Editors. The responsibility of the Publication Manager is to
assure the flawless composition of PDF and XML documents and their publication in the electronic Journals.

### 2.2. Example

### Frontiers in Neuroscience Field Journal

As a non-limiting example, the Frontiers in Neuroscience Journal is a hardcopy journal and operated by world leaders in the field of Neuroscience acting as Field Chief Editors. All articles reaching the Field tier will have gone through the Frontiers Evaluation and Distillation System and represent the top 10% most read and outstanding papers across all Subfields. At this tier, articles have to be re-written in order to address the entire Neuroscience community. Frontiers in Neuroscience Field Chief Editors will decide together with the Publishing Editor on the regularity of the Journal issues depending on the distillation rate of processed articles by Frontiers.

2.2.1. Field Chief Editors

Field Chief Editors operate the Frontiers in Neuroscience Journal. Their responsibilities are to
recruit and manage the Specialty Chief Editors,
help to recruit the specialty field Associate Editorial Board if necessary,
review the top 10% outstanding research coming from the specialties to the Frontiers in Neuroscience Journal,
compile the Frontiers in Neuroscience Journal,
ensure that Specialty Chief Editors perform their duties and act according to the rules and regulations of Frontiers,
contribute a paper to the inaugural issue of the Frontiers in Neuroscience Hardcopy Journal.
promote the Frontiers in Neuroscience Journal.

Field Chief Editors are required to register with Frontiers and verify other Frontiers applicants.

Field Chief Editors are contracted by the Frontiers Research Foundation on 1-year renewable contracts and receive remuneration for each paper handled. The remuneration scheme will be elaborated in a separate document.

2.2.2. Referees

Referees review the selected articles. Since these articles were already reviewed at the Specialty level, they require only a light review to ensure that the main contents of the paper remain the same and the same reviewers as previously involved may be consulted. Their interactions with Authors are overseen by the Field Chief Editors. The responsibility of referees at the Field tier is to
review articles according to the rules and regulations of Frontiers.

2.2.3. Publication Editor

Field Chief Editors are assisted by a Frontiers Publication Editor, whose team oversees the work of Copy Editors, Graphics Editors, Multi-Media Editors, PDF Editors, XML Editors and Informatics Editors. The responsibility of the Publication Manager is to
assure the flawless composition of PDF and XML documents and their publication in the hardcopy Frontiers in Neuroscience Journal as well as on the Frontiers in Neuroscience Journal website.

### 3. Journals Rules & Regulations

### 3.1. Author Rights & Responsibilities

§1: Authors must register with the Journal system and submit a complete CV and list of publications. The publications are used to automatically construct an Author Citation Impact, which will be used to assign Referees with the appropriate level of expertise and experience.
§2: Authors must agree to the Academic Model policy applied to the Journal Series.
§3: Author must agree to the rules & regulations of submission, review, evaluation and recognition.
§4: Authors reserve the right to demand immediate internet publication of a brief Paper Pending Abstract based on a submitted paper, provided the accompanying paper is accepted for in-depth review.
§5: Authors reserve the right to initiate an arbitration at any stage of the submissions and review process if they feel that the handling of their paper has been biased (see Author Initiated Arbitration).
§6: Authors are obliged to fulfil Referee revision requests related to validity of experiments and flaws in the results and analysis.
§7: Authors are encouraged, but not obliged, to meet all revision requirements of the Referees aimed at enhancing the quality of the research and the written paper as pertains to interpretation of results. Authors need to be aware that Referees may withdraw if they feel that the Authors are unwilling to make important changes. Withdrawal of a Referee will delay the review process, since a new Referee may have to be invited.
§8: Authors reserve the right to demand publication of their submitted paper following review by two Referees, unless Referees can identify objective errors.
§9: Authors are obliged to pay a fee for the submission, review, editing and publication of their research paper.
§10: Authors are not responsible for any additional costs such as hard copy publication, colored figures, etc.
§11: The Authors will pass full user rights to the system to publish and promote the article as it chooses.
§12: Authors are the owners of the paper and can reproduce copies of their articles in any way they chose and freely disseminate these as reprints.
§13: Authors agree to the free dissemination of their articles by any third party organizations.

### 3.2. Referees Rights and Responsibilities

§1: Referees are required to accept the Authors Rights and Responsibilities clause, as well as all Academic Review Policies and the Academic Model in general.
§2: Two Referees will be responsible for each submitted paper.
§3: Referees are required to activate the review process within 2 business days by entering the review site that will be prepared for the paper.
§4: A Referee may decline to review a paper 1) because of time constraints, 2) because the paper does not meet the ethic standards of the Journals, or 3) because the general quality of the paper is too low to make a review possible.
§5: If ethics standards and general quality standards are met and the Referee has no time constraints, the Referee may not decline to the in-depth review for other professional reasons. Referees will need to begin the review process.
§6: If any Referee declines to review because of general quality, the Associate Editor is alerted to trigger the search for another Referee. All Referees, the Associate Editor and Specialty Chief Editor must decline to review a paper because of quality, before the paper can be rejected without in-depth review. Only the Specialty Chief Editor may reject the paper. Papers rejected without in-depth review will be referred to a Science Quality Training Center in the future.
§7: If Referees reject a paper because of ethical standards Associate and Specialty Chief Editors are automatically alerted. In addition, the ethics board must be notified of the incident.
§8: After activation of the review, the first task of a Referee is to agree to perform an in-depth review of the paper.
§9: Referees are obliged to provide comments, rank the paper, respond to questions and generally communicate directly with the Authors in a real-time interactive forum from the moment that the Referees activates the review process until the end of the review process.
§10: Referees reserve the right to remain anonymous until the end of the review process.
§11: Referees are obliged to release their identities upon completion of the review process, after the paper is accepted for publication.
§12: Referees reserve the right to withdraw from the review process at any time.
§13: Referees reserve the right to remain anonymous in the event that the Referee decides to withdraw from the review process.
§14: Referees reserve the right to remain anonymous in the event of an Arbitration verdict against the Referee and the decision to withdraw from the review process.
§15: Referees reserve the right to request Arbitration in the event that an issue remains unresolved.
§16: Referees are invited to publish a joint commentary of approximately a page to be linked to the paper. Both Referees must agree and author the Commentary. Referees may decline, which would indicate that not all Articles will be associated with a Commentary.

### 3.3. Associate Editor Rights and Responsibilities

§1: Associate Editors are required to accept the Authors Rights and Responsibilities clause, as well as all Academic Review Policies and the Academic Model in general.
§2: Associate Editors reserve the right to appoint and remove Referees from their Referee Board.
§3: Associate Editors are obliged to handle the review process of all submitted work without any bias and discrimination.
§4: Associate Editors are obliged to appoint Referees to submitted articles as long as there is no automated Referee selection system. Upon installation of the automated Referee selection system the Associate Editors are obliged to monitor the Referee selection process.
§5: Associate Editors are obliged to review articles when Referees cannot be found to review an article which has sufficient quality.
§6: Associate Editors are obliged to monitor the review process unfolding on the Review Site and ensure that the Referees perform the review timely and fairly.
§7: Associate Editors are responsible for enforcing Journals Rules and Regulations regarding the review process.
§8: Associate Editors reserve the right to initiate Arbitration in the case of dead end disputes.
§9: Associate Editors are obliged to introduce an expert arbitrator or may themselves act as arbitrators between Authors and Referees in case of unresolved disputes.
§10: Associate Editors reserve the right to remove a Referee from the review process.

3.4. Specialty Chief Editor Rights and Responsibilities

§1: Specialty Editors are required to accept the Authors Rights and Responsibilities clause, as well as all Academic Review Policies and the Academic Model in general.
§2: Specialty Editors reserve the right to appoint and remove Associate Editors from their Editorial Board.
§3: Specialty Chief Editors ensure that Associate Editors perform their duties and act according to the Journals Rules and Regulations.
§4: Specialty Chief Editors are responsible for upholding and enforcing all Journals Rules and Regulations.
§5: Specialty Chief Editors are obliged to promote their Specialty Journal and the Academic Model.
§6: Specialty Chief Editors are obliged to act as arbitrators between Authors and Referees, when an Associate Editor cannot resolve the conflict alone.
§7: Specialty Chief Editors are obliged to review articles when Referees cannot be found to review an article which has sufficient quality.
§8: Specialty Chief Editors are obliged to act as arbitrators in case of unresolved conflicts between Authors and Referees.
§9: Specialty Chief Editors reserve the right to reject papers for publication.
§10: Specialty Chief Editors reserve the right to remove an Associate Editor from the review process.
§11: Specialty Chief Editors reserve the right to remove a Referee from the review process.
§12: Specialty Chief Editors are responsible for enforcing the ethical standards of submitted research.
§13: Specialty Chief Editors are invited to the Scientific Advisory Board.

### 3.5. Field Chief Editor Rights and Responsibilities

§1: Field Chief Editors are required to accept the Authors Rights and Responsibilities clause, as well as all Academic Review Policies and the Academic Model in general.
§2: Field Chief Editors reserve the right to appoint and remove Specialty Chief Editors. In case of several Field Chief Editors, this decision must be unanimous.
§3: Field Chief Editors ensure that Subfield Editors perform their duties and act according to the Journals Rules and Regulations.
§4: Field Chief Editors are responsible for upholding and enforcing all Journals Rules and Regulations.
§5: Field Chief Editors are obliged to promote the Journals and the Academic Model.
§6: The Field Chief Editors oversee the review process for the papers.
§7: The Field Chief Editors are invited to the Scientific Advisory Board.

### 3.6. Journals Ethics

§1: The Ethics Board of the Research Foundation will define the ethics standards of all Journals. The Ethics Board will consist of leading ethicists representing each continent in the world.
§2: All papers must conform to the ethical standards set forth by the Ethics Board.
§3: The Research Foundation will post a model ethics document for review.

### 3.7. Copyrights

§1: Authors agree that the Journals can publish, re-publish and generally use the paper and data as the Journal sees appropriate.
§2: Authors retain the copyright to freely distribute their paper.

### 3.8. Rejection Rules

3.8.1. General Rules

§1: Associate Editors and Referees may suggest to reject a paper for two reasons only:
1) the general quality of the paper may be too low (including objective errors);
2) the paper does not meet ethical standards for scientific procedures and/or animal care.
§2: Before a paper is rejected for ethical or quality reasons, an arbitration must be performed by the Associate Editor and the Specialty Chief Editors.
§3: Only a Specialty Chief Editor can reject a submitted paper.
§4: Papers can only be rejected by Specialty Chief Editors in accordance with the Journals Rules and Regulations.
§5: The Research Foundation Ethics Board must be notified of all papers rejected for ethical reasons.
§6: The Research Foundation Scientific Board must be notified of all papers rejected for poor quality reasons.
§7: The Research Foundation will assign ad hoc committees to screen rejected papers periodically to verify and monitor the Rejection System.

3.8.2. Rejection without Review

§1: Papers can be rejected without review either because initial screening reveals that either the quality of the paper is too low, contains obvious objective errors or the ethical standards are not met and the Journal is unable to find 2 Referees to perform the review and neither the Associate Editor nor the Specialty Editor want to perform the review.
§2: Authors of papers rejected without in-depth review because of quality will be notified that the Journal could not find 2 expert Referees that were willing to review the paper, because the general quality was too low. The Authors are referred to a Science Quality Training Center for assistance in their research and manuscript preparation.

3.8.3. Rejection During Review

§1: The paper can be rejected during review if experiments are found to be invalid or if an objective error is found that cannot be corrected.
§2: Authors and Referees may trigger an arbitration to resolve a dispute about an invalid experiment or objective error.
§3: The Associate Editor arbitrates conflicts or calls in an expert to arbitrate.
§4: Associate Editors, Referees and called in experts may recommend to reject a paper.
§5: In case the Associate Editor agrees with the Referees to reject the paper, the Specialty Chief Editor is called in to arbitrate.
§6: The Specialty Chief Editor may override the Associate Editor and Referees recommendation to reject the paper and can call in further referees or decide to referee the paper him/herself.
§7: The Specialty Chief Editor may agree with Associate Editor and Referees to reject the paper. In this case the Specialty Chief Editor may reject the paper.
§8: The paper pending abstract is withdrawn if a paper is rejected.

3.8.4. Objective Error Clause

§1: The Objective Error Clause states that the error identified in the research performed is one that is generally accepted by the community.
§2: In the case of a dispute, either Referees or Authors can trigger an arbitration, which will evaluate whether this is an objective error.

### 3.9. Arbitration

§1: Arbitration is the process of resolving a dispute by an impartial body. In many sciences such a body is not possible.
§2: Authors, Referees or Associate Editors can trigger arbitrations.
§3: At early stages of a Journal launch, the Associate Editor arbitrates conflicts or calls in an expert to arbitrate.
§4: At later phases, the Associate Editor will call in Expert Arbitrators with higher Author Impact scores to arbitrate
§5: Specialty Chief Editors may be called into an arbitration, if the Associate Editor could not resolve the conflict.
§6: The Specialty Chief Editor may perform the final arbitration verdict taking into consideration the recommendations of the Associate Editor, Referees and/or Expert Arbitrator.
§7: Associate Editors, Referees and called in Expert Arbitrators may recommend to reject a paper.
§8: The Specialty Chief Editor may agree with Associate Editor and Referees to reject the paper. In this case the Specialty Chief Editor may reject the paper.
§9: The Specialty Chief Editor reserves the right to override the rejection recommendation of Associate Editor, Referees and or Expert Arbitrators and can call in further referees or decide to referee the paper him/herself.
§10: If Authors do not comply with the final arbitration verdict of the Specialty Chief Editor, he/she may decide to reject the paper.
§11: In case of rejection, arbitration reports will be filed with the Research Foundation Ethics or Scientific Boards for later ad hoc quality control.

### 3.10. Paper Acceptance

§1: Paper acceptance requires that all Referees agree. Convergence is facilitated in the Real-Time Interactive Review Forum where Referees can interact with the Authors.
§2: The Referees may also submit a Commentary to be linked to the paper.

### 4. Formulas & Algorithms

1.1. Internet-Based Reader Evaluation

1.1.1. Internet-Based Reader General Expertise Index (GEI):
1.1.1.1. An internet-based database of the expertise of each reader is created, and used to calculate the Reader General Expertise Index, RGEI. Readers that do not enter profiles are assigned the non-scholar expertise level.
1.1.1.2. Scores by educational level; non-scholar (score 1), company executive (approaches score 2 exponentially with years, peaks at 10 years), Bachelors (score 3), MSc (score 4), PhD (score 5), Postdoctoral student (score 6), independent researcher (score 7), assistant professor (score 8), associate professor (score 9), full professor (score 10), years practiced as a clinician (approaches 10 exponentially with years, peaks at 10 years).
1.1.1.3. If more than 1 score is relevant, the highest is taken.

1.1.2. Internet-Based Reader Remoteness Index (SEI):
1.1.2.1. The formulation determines the distance in expertise levels between the article or author and the reader.
1.1.2.2. Different expertise levels are assigned a different normalizing score as follows; from a specialist field, eg molecular neuroscience field (score 1), from a field, eg neuroscience (score 2), from a discipline, eg science (score 3), from a category, eg science and medicine (score 4), outside a category (score 5), non-scholar (score 6), journalist (7).

1.1.3. Internet-Based Reader Specialist Expertise Index (RSEI)
1.1.3.1. The aim of this formulation is to provide a higher score for the more educated and more specialized readers.
1.1.3.2. RSEI=GEI+(8−SEI)

1.1.4. Reader Social Relevance Index (SRI):
1.1.4.1. The aim of this formulation is to provide a higher score for readers that are further from the field (ie towards the layman), but also score even higher when more expert readers access more remote articles.
1.1.4.2. SRI=GEI+SEI

1.2. Internet-Based Scholarly Article Evaluation

1.2.1. Article Excellence Impact (AEI)
1.2.1.1. An application server uses the REI to scale the importance of the reader accessing different parts of the paper. The goal of this algorithm is to award higher scores to articles for accessing more in depth parts of articles by more expert readers.
1.2.1.2. AEI=sum of all(C1*article commentary click*REI+C2*title click*REI+C3*abstract click*REI+C4*full text click*REI+C5*figure click*REI C6*supplementary data click*REI C7*pdf download*REI C8*supplementary data download*REI) where C1-7 are different coefficients to assign importance to the clicking or downloading each part of the paper. Eg C1=1; C2=2 etc.

1.2.2. Article Relevance Impact (ARI)
1.2.2.1. An application server uses the SRI to scale the importance of the reader accessing different parts of the paper. The goal of this algorithm is to award higher scores to articles accessed by readers further from the field of specialization and scaled by expertise.
1.2.2.2. ARI=sum of all(C1*article commentary click*SRI+C2*title click*SRI+C3*abstract click*SRI+C4*full text click*SRI+C5*figure click*SRI C6*supplementary data click*SRI+C7*pdf download*SRI C8*supplementary data download*SRI) where C1-7 are different coefficients to assign importance to the clicking or downloading each part of the paper. Eg C1=1; C2=2 etc.

1.3. Internet-Based Author Evaluation

1.3.1. Author Citation Impact (ACI):
1.3.1.1. An application server asks the user to locate a paper by the Author
1.3.1.2. An application searches for all related papers
1.3.1.3. An application extracts all papers by the author
1.3.1.4. An application automatically constructs a profile using the key words of the paper and methods and processes used
1.3.1.5. An application searches for all papers by the author limited by the Author's profile to prevent extracting papers from authors with the same name
1.3.1.6. An application searches internet databases for the number of citations for each of the papers authored.
1.3.1.7. A formula is used to calculate the Author Citation Impact (ACI) as; C1*Σall(research article*#citations) where C1 is a coefficient applied to normalize across fields of research.

1.3.2. Author Publications Impact (API):
1.3.2.1. A web server allows authors to submit the full professional profile for archiving in a resident database.
1.3.2.2. An application server searches internet databases for the number of citations for each article, book or book chapter by the author.
1.3.2.3. An application server searches the internet for the number of references made to the article in the internet.
1.3.2.4. An application server assigns the total number of citations and internet references to each scientific work.
1.3.2.5. The resident database is searched for the number of patents filed and granted by the author.
1.3.2.6. A application server calculates the Author Research Impact; ARI=(C1*Σall(research article*#citations)+C2*#books*#copies+C3*book chapters*#copies+C4*#patents granted+C5*#patents applied)+(C1*Σall(research article*#internet references)+(C2*#books*#internet references+C3*book chapters*#internet references) where C1-C3 are coefficients to normalize for the importance of each scientific work.

1.3.3. Frontiers Author Impact (FAI):
1.3.3.1. The FAI is the sum of all AEI+ARI for each article published in Frontiers.

1.4. Internet Based Referee Evaluation
1.4.1. The Referee Contributions Impact (RCI) is calculated as the sum of all FSI for each paper refereed.

1.5. Internet-Based Referee Identification & Assignment Algorithm (IRIA)
1.5.1. Citation-Based Automated Referee Identification & Assignment
   1.5.1.1. Find related papers
   1.5.1.2. Find number of citations of related papers
   1.5.1.3. Extract Authors of related papers
   1.5.1.4. Calculate individual related paper Author citations
   1.5.1.5. Rank Authors according to citations
   1.5.1.6. Re-rank authors according to referee work-load in Frontiers
   1.5.1.7. Invite top 5 referees to the review forum
   1.5.1.8. Three required to start the review
   1.5.1.9. If not enough referees after 2 business days, invite 3 more referees
   1.5.1.10. If 3 referees are not obtained, automatically alert section editor

1.6. Author Profile-Based Automated Referee Identification & Assignment Algorithm (PARIA)
1.6.1. Find Related Papers
1.6.2. Extract Authors as candidate referees
1.6.3. Calculate Author Citation Impact (ACI)
1.6.4. Rank candidate referees according to ACI
1.6.5. Re-rank authors according to referee work-load in Frontiers
1.6.6. Invite top 5 referees to the review forum
1.6.7. Three required to start the review
1.6.8. If not enough referees after 2 business days, invite 3 more referees
1.6.9. If 3 referees are not obtained, automatically alert section editor

### 2. The Review Method

2.1.1. Automated Referee Selection (ARS) using the IRIA algorithm in the first stage of a Journal and the PARIA algorithm when the journal has registered enough referees.
2.1.2. Referees are referred to a webpage where they can view the submitted manuscript in full XML text version.
2.1.3. Referees must decide whether they agree to review the paper
2.1.4. When all three referees agree to review the title, authors and abstract are published on-line as “Paper Pending” and the paper enters the review process
2.1.5. Paper Pending is a novel idea to allow submitted research articles to claim priority before an in depth review
2.1.6. Referees have a choice to refuse to review the manuscript on the basis of 1) general quality and scientific level, 2) inappropriate expertise, 3) other reasons.
2.1.7. If a referee declines the review request because of inappropriate expertise or other reasons, the application server automatically invites two additional referees
2.1.8. If one referee declines to review the manuscript because of general quality 2 additional referees are invited to review the manuscript
2.1.9. If 2 or more referees decline to review the manuscript because of general quality,
   2.1.9.1. the application server automatically alerts the section editor,
   2.1.9.2. the section editor makes the decision whether to invite additional referees or to reject the paper because of general quality
   2.1.9.3. if the paper is rejected the author is referred to a Frontiers Science Writing Service site that consults on producing high level scientific research and papers
   2.1.9.4. the Chief Editor is alerted if any paper is rejected
   2.1.9.5. the Chief Editors periodically invite external examiners to determine whether section editors made correct and unbiased decisions
2.1.10. Referees are transferred to a Real-Time Peer Review Forum (RTR) web page
   2.1.10.1. The RTR page allows;
      2.1.10.1.1. Real-time editing of the manuscript by the author with instantaneous internet visible updating of the manuscript
      2.1.10.1.2. Real-time comments by each referee in referee 1-3 edit boxes
      2.1.10.1.3. Authors and referees are able to see each others comments and discuss the revisions required
      2.1.10.1.4. Authors and referees have options to send an email alert to each other when changes are made
   2.1.10.2. Referees have the options to;
      2.1.10.2.1. Accept the revisions
         2.1.10.2.1.1. Only when all three referees accept the revisions made by the authors, the paper is accepted for publication
      2.1.10.2.2. Trigger an arbitration in the case of a dispute
         2.1.10.2.2.1. If an arbitration is triggered, the Section Editor is alerted;
         2.1.10.2.2.1.1. The section editor is able to review the latest manuscript as well as the comments of the author and referees
         2.1.10.2.2.1.2. The Section Editor decides on the actions required to resolve the arbitration
      2.1.10.2.3. Withdrawing from a review
         2.1.10.2.3.1. Referees can withdraw from a review in the case of an unresolved dispute or because of non-professional reasons
         2.1.10.2.3.2. The referee withdraws and remains anonymous
         2.1.10.2.3.3. The Section editor invites an additional referee to join the review forum
         2.1.10.2.3.4. If all three referees withdraw from the review because of an unresolved dispute, the Section Editor judges whether to re-enter the paper for review or to reject the paper
   2.1.10.3. Internet Forum for Joint Referee Authorship
      2.1.10.3.1. When all three referees accept the revisions made, a referee Commentary page is created
      2.1.10.3.2. Referees are able to jointly construct a 1 page commentary on the paper for joint authorship
   2.1.10.4. Real-Time Copy Editing Facility
      2.1.10.4.1. When the referee commentary is completed a real-time copy editing site is created
      2.1.10.4.2. Only the copy-editor is able to edit the manuscript and referee commentary
      2.1.10.4.3. Comment boxes are provided for the copy editor, author and referees to enter a real-time questions and answer of copy editing issues.
      2.1.10.4.4. Copy editor is able to email alert author or referees

### 3. Business Methods and Approaches

3.1. Internet-Based Human Resources
3.1.1. On-line Applications Method
   3.1.1.1. Freelance candidates enter their profile
   3.1.1.2. Freelance candidate select the services they wish to provide
   3.1.1.3. Freelancers receive access to an examinations page
      3.1.1.3.1. The examinations page describes the procedures of;
         3.1.1.3.1.1. The examinations
         3.1.1.3.1.1.1. different levels of difficulty papers (length & specialty)
      3.1.1.3.1.2. obtaining the exam
      3.1.1.3.1.3. submission of the completed project
      3.1.1.3.1.4. evaluation of the project
3.1.2. Automated Performance Evaluation
   3.1.2.1. Copy Editing (as an example)
      3.1.2.1.1. The Freelance candidate submits the copy-edited paper
      3.1.2.1.2. Papers of different levels of difficulty are provided
         3.1.2.1.2.1. The author
      3.1.2.1.3. The paper is automatically matched to the ideal copy-edited paper
         3.1.2.1.3.1. A score obtained depends on;
         3.1.2.1.3.1.1. Time taken
         3.1.2.1.3.1.2. Correlation between the submitted paper and the ideal paper
      3.1.2.1.4. The author receives a ranking which;
         3.1.2.1.4.1. Determines whether the service is of sufficient quality
         3.1.2.1.4.2. Determines the level of difficulty
         3.1.2.1.4.3. Determines promotion to copy-editing manager
3.1.3. Automated Performance Tracking
   3.1.3.1. Frontier sites allows feedback on the quality of papers from;
      3.1.3.1.1. Readers
      3.1.3.1.2. Authors
      3.1.3.1.3. Referees
      3.1.3.1.4. Copy-editing managers
3.1.4. Rating-based assignments
   3.1.4.1. Freelancers are assigned tasks according to their ranking
3.1.5. Meritious Payment
   3.1.5.1. Freelancers are paid according to their
      3.1.5.1.1. Service ranking
      3.1.5.1.2. level of difficulty of the service provided

3.2. Automated Assignments to Service Providers
3.2.1. Papers are Submitted
3.2.2. A server application evaluates the level of difficulty of a paper based on a specialty index
   3.2.2.1. A paper specialty index (PSI) is calculated automatically based on the number of specialty terms and formulas used in the paper
   3.2.2.2. A reference lay dictionary is used for the comparative analysis
3.2.3. Potential freelance service providers are selected based on
   3.2.3.1. the level of difficulty of a paper
   3.2.3.2. the ranking of a service provider
   3.2.3.3. the workload of a service provider
3.2.4. An email invitation is automatically sent to the service provider to accept the assignment
   3.2.4.1. A link is provided to the assignment site
   3.2.5. The service provider enters the service assignment site
   3.2.6. The service provider must accept the terms and conditions of the assignment
   3.2.7. The service provider gains access to the project

3.3. Collaborative Internet-Based Authoring
3.3.1. Frontier Books—Collaborative internet based book authoring
   3.3.1.1. The site allows for
      3.3.1.1.1. Editors to outline a prospective paper
      3.3.1.1.2. Editors to invite authors to contribute chapters or sections of chapters
      3.3.1.1.3. On-line authoring
         3.3.1.1.3.1. Authors are able to write or upload work
         3.3.1.1.3.2. Upon submission, the text and illustrations are automatically formatted according to a basic standard
         3.3.1.1.3.3. The updated text can be viewed in real-time by all authors

3.4. Discovery Environment

The discovery environment is a series of specialist services for readers to obtain an indept “discovery” of scientific work, authors and organizations. Some services require custom research by service providers while some are automated. These services are paid services
3.4.1. Discovery Article Impact
   3.4.1.1. Basic level service—the internet-based scholarly article impact evaluation (see above)
   3.4.1.2. An application server search internet databases for all related papers
   3.4.1.3. An application server sorts all papers by date
   3.4.1.4. The number index of impact is determined as
      3.4.1.4.1. The number of related papers before/after
      3.4.1.4.2. The years considered are equal for the past and future of a paper
3.4.2. Discovery Author Impact
   3.4.2.1. In addition to the internet-based automatic author evaluation, a service is provided to carry out a custom research on the impact of an author on the field
3.4.3. Discovery Laboratory, Department, Institute, Country Impact
   3.4.3.1. Custom service to determine the impact of the work of a particular laboratory
3.4.4. Discovery Circles Of Relevance (DCor)
   3.4.4.1. The DCor algorithm has two parts
      3.4.4.1.1. Automatic part
         3.4.4.1.1.1. This part performs internet searches for any fields of society where the scientific work could be relevant
         3.4.4.1.1.1.1. Commercial industries
         3.4.4.1.1.1.2. Hospitals and clinics
         3.4.4.1.1.1.3. Governmental and non-governmental organizations
         3.4.4.1.1.1.4. Primary and secondary education
         3.4.4.1.1.1.5. Other fields of society
         3.4.4.1.1.2. Search results are ranked within categories such as methods & approach, new technologies and applications, etc
         3.4.4.1.1.3. Websites duplicates are removed
         3.4.4.1.1.4. Websites pointing to a website are listed separately under “pointing pages”
      3.4.4.1.2. Custom part
         3.4.4.1.2.1. Service providers perform checks on the automated search results to verify the circles of relevance
         3.4.4.1.2.2. Service providers perform additional searches to add to the circles of relevance
3.4.5. Discovery Related Works
   3.4.5.1. Abstracts
   3.4.5.2. Articles
   3.4.5.3. Books
   3.4.5.4. Conferences
   3.4.5.5. Patents
   3.4.5.6. Websites
   3.4.5.7. Companies
3.4.6. Discovery Related People & Organizations
   3.4.6.1. Authors
   3.4.6.2. Laboratories
   3.4.6.3. Institutions
   3.4.6.4. Companies
3.4.7. Discovery Research Partners
   3.4.7.1.
3.4.8. Frontiers Discovery Research Funding
3.4.9. Frontiers Discovery Reduced Science
3.4.10. Frontiers Discovery Market

3.5. RT Internet-Based Patent Authoring
3.5.1. Frontiers Discovery Patentability
3.5.2. Automated Law Company Assignment
3.5.3. RT-Internet based collaborative patent authoring

1. A technical method, for evaluation, publication and distillation of information, such as scientific articles and other similar work, said method, process and system comprising at least the following technical process steps
(1) an interactive online reviewing process of said information before it is published;
(2) a publication process of said information if accepted;
(3) an evaluation process of said information once published;
(4) a distillation process of said published information in a tier filtering system based on said evaluation process.

2. The method as defined in claim 1, wherein the reviewing process comprises at least the following steps:
(1.1) electronic registration of an author in an author database if said author is not present in said database;
(1.2) electronic submission of said information by a registered author;
(1.3) selection of an associate editor in a database of associate editors;
(1.4) selection of at least two referees from a referee database;
(1.5) first evaluation of said information by said selected referees and based on said first evaluation, rejection of said information or acceptation for further evaluation of said information by said referees;
(1.6) in case further evaluation is accepted by at least two referees, real-time interactive review of said information with said referees and said author until said referees accept said information for publication.

3. The method as defined in claim 2, wherein the step (1.1) of electronic author registration comprises at least the following registration steps:
(1.1.1) online submission of information related to the author;
(1.1.2) online accreditation of said author by a person already registered;
(1.1.3) generation of an Author Impact Score (RIS) by means of predetermined rules.

4. The method as defined in claim 2, wherein the step of selection of an associate editor (1.3) is made either manually by said registered author submitting information or automatically based on key-words qualifying said information and matching said key-words with an editor profile.

5. The method as defined in claim 2, wherein the step of selecting referees (1.4) comprises at least the following selection steps:
(1.4.1) manual or automatic pre-selection of at least two most appropriate referees on the basis of predetermined rules comprising
defining the areas of competence of each referee, matching said areas with keywords related to the information, in the automatic pre-selection said rules including defining a Referee Impact Score (RIS) for each referee and ranking said pre-selected referees on the basis of availability criteria;
(1.4.2) automatically inviting each pre-selected referee according to the ranking until at least two referees have accepted their pre-selection, thus becoming selected referees.

6. The method as defined in claim 4, wherein the pre-selection process includes a comparison of the Author Impact Score and of the Referee Impact Score and an automatic preselection of the referees having an impact score equal or higher than the Author Impact Score.

7. The method as defined in claim 2, wherein the first evaluation step
(1.5) comprises at least the following steps:
(1.5.1) evaluation of the quality of the information and rejection if insufficient or if ethical standards are not met;
(1.5.2) in case of rejection by one referee, alert of the Associate Editor and arbitration by said Associate Editor on the fairness of the decision;
(1.5.3) if necessary, selection of more referees or participation of the Associate Editor as a referee in the evaluation;
(1.5.4) in case of rejection by two referees, alert of the Associate Editor and arbitration by said Associate Editor on the fairness of the decision;
(1.5.5) if said Associate Editor accepts the rejection, alert of a Specialist Chief Editor to make a final decision of acceptation or rejection;
(1.5.6) if necessary, new selection of referees with or without the Specialist Chief Editor participating a referee in the evaluation;
(1.5.7) in case of final rejection of the information, alert of the author and starting of an optional online Consultancy process;
(1.5.8) in case of acceptation of the information, further evaluation of said information.

8. The method as defined in claim 2, wherein said real-time interactive review of information (1.6) comprises at least the following steps:
(1.6.1) opening of a closed and independent review forum in which said selected referees post comments in an online accessible manner for the author only and information of said author;
(1.6.2) closing of said independent review forum and opening of an interactive real-time forum in which said referees post online comments accessible to other referees of said at least two selected referees and the author and information of said other referees and said author of posted comments;
(1.6.3) creating history logs of all exchanges made on said forums;
(1.6.4) closing of said interactive forum.

9. The method as defined in claim 1, wherein said publication process (2) comprises at least the following steps:
(2.1) format and copy editing of the information accepted to be published;
(2.2) placing of the information under electronic form in an online accessible site.

10. The method as defined in claim 1, wherein the evaluation process
(3) of said information once published comprises at least the following steps:
(3.1) registration of each reader in a reader database and determination of a reader profile for each registered reader;
(3.2) evaluation of said published information by said registered readers and scoring by said readers of said information in an online accessible information scoring database;
(3.3) ranking of said published information at least on the basis of the corresponding scoring in said scoring database.

11. The method as defined in claim 1, wherein the distillation process
(4) comprises at least the following steps:
(4.1) definition of several tier levels, starting from a most specialized field level and going up to most general field level;
(4.2) publishing said information firstly under a most specialized field level;
(4.3) based on the evaluation process of said published information, moving said information up one tier level to a more general field level among said levels;
(4.4) further evaluation process of said published information;
(4.5) depending on the result of the further evaluation process, moving said information further up one tier level among said level;
(4.6) repetition of steps (4.4) and (4.5) until the information reaches the most general field level.

12. A computer internet-based technical system for carrying out the method as defined in claim 1, whereby the system comprises at least:
interactive means for receiving said information in electronic form and for allowing an interactive review of said information;
online publication means for allowing an online electronic publication of said information under a given publication level;
evaluation means allowing the evaluation of said published information by readers;
distillation means for automatically processing said published information in a tier
filtering system with several publication levels using results provided by said evaluation means.

13. A system as defined in claim 12, wherein said interactive means comprise at least
a database for registration of Authors of said information,
receiving means for receiving and storing said information,
associate editor selection means to choose an associate editor in a database of associate editor profiles,
referee selection means for selecting at least two referees in a referee database,
interactive reviewing means allowing interactive exchange of reviews of said information between the referees and the Author until said information is accepted for publication.

14. A system as defined in claim 13, wherein said author database comprises data related to authors of information.

15. A system as defined in claim 13 said associate editor selection means are able to choose an associate editor automatically in said database by a matching of keywords qualifying said information with associate editor profiles.

16. A system as defined in claim 13, wherein said referee selection means comprise at least
pre-selection means for pre-selecting at least two most appropriate referees on the basis of predetermined rules,
ranking means for ranking the availability of said pre-selected referees,
inviting means for repeatedly inviting each pre-selected referee on the basis of the ranking until two referees have accepted pre-selection.

17. A system as defined in claim 16, wherein said pre-selection means additionally comprise comparison means for comparing an Author Impact Score value with a Referee Impact Score value and for automatic pre-selection of referees having Referee Impact Score value higher than said Author Impact Score value.

18. A system as defined in claim 13, wherein said interactive reviewing means comprise at least:
online comments posting means allowing the posting of comments by referees and the consultation of said comments by the author and/or by other pre selected referees,
exchange means allowing an online exchange of comments between the pre-selected referees and the author,
exchange memory means to keep a history of exchanges of comments.

19. A system as defined in claim 12, wherein the evaluation means comprise at least
reader registration means for registering readers in a reader database with reader's profile;
a scoring database for storing the scores attributed by said readers to the published information;
ranking means for ranking said published information on the basis of scoring in said scoring database.

20. A system as defined in claim 19, wherein the distillation means comprise at least
tier level defining means to define said several levels of publication of said information, from a most specialized to a most general level;
ranking evaluation means to consider the result given by said ranking means and to change the publication level attributed to said information in said levels of publication in order to publish said information in a higher level.

21. A publication model for information, such as scientific information, wherein said information is submitted in an interactive review environment to be reviewed before publication in a tier system of publication levels, starting from a more specific level to a more general level,
wherein when accepted for publication, said information is published in a specific level,
wherein once published in said specific level said information is evaluated by readers,
wherein on the basis of the evaluation by said readers, said information is promoted for publication in a more general level, said evaluation and said promotion being carried out repeatedly until the information has been published in the most general level.
